(19) United States
(12) Patent Application Publication
(10) Pub. No.: US 2013/0194421 A1
(43) Pub. Date: Aug. 1, 2013

(54) INFORMATION PROCESSING APPARATUS, INFORMATION PROCESSING METHOD, AND RECORDING MEDIUM, FOR DISPLAYING INFORMATION OF OBJECT

(71) Applicant: CASIO COMPUTER CO., LTD., Tokyo (JP)

(72) Inventor: Kazunori KITA, Tokyo (JP)

(73) Assignee: CASIO COMPUTER CO., LTD., Tokyo (JP)

(21) Appl. No.: 13/740,583

(22) Filed: Jan. 14, 2013

(30) Foreign Application Priority Data
Jan. 30, 2012 (JP) 2012-016721

(51) Int. Cl. H04N 7/18

(52) U.S. Cl. CPC H04N 7/18
USPC 348/143

(57) ABSTRACT

An information processing apparatus includes: a designation unit that designates an arbitrary area in a real space at arbitrary timing; an acquisition unit that acquires information regarding an object existing in the real space; a detection unit that detects an object existing in an area designated by the designation unit at timing designated by the designation unit, among a plurality of objects existing in the real space; and a selection-display unit that selects and displays information corresponding to the object detected by the detection unit, from among a plurality of pieces of information that can be acquired by the acquisition unit.

This application is based on and claims the benefit of priority from Japanese Patent Application No. 2012-016721, filed on 30 Jan. 2012, the content of which is incorporated herein by reference.

### BACKGROUND OF THE INVENTION

1. Field of the Invention

The present invention relates to an information processing apparatus, an information processing method, and a recording medium, all of which make it possible to perceive information of a predetermined object from among a plurality of objects.

2. Related Art

At gyms or places for team sports, a manager, a coach, a supervisor, etc. train and instruct a large number of persons such as players, students and children under their supervision. An observing person such as a manager, a coach and a supervisor is hereinafter referred to as an “observer”. An observed person such as a player, a student and a child is hereinafter referred to as an “observed person”.

The observer observes and evaluates various conditions of the observed persons, for example, health conditions and physical conditions, conditions of physical strength and athletic capabilities, progressive conditions of sports skills, etc.

In a case in which a condition of the observed person is abnormal, the observer supervises, protects, or rescues the observed person as well. Therefore, the observer is required to quickly discover an abnormal condition of the observed persons, and to take appropriate countermeasures. However, conventionally, since observers visually determine conditions of a plurality of observed persons, it has been difficult to discover an abnormal condition of the observed persons. Furthermore, since an observed person who is in the middle of playing sports does not always remain in a constant place, it may be even difficult for the observer to identify an observed person in some cases.

Accordingly, first of all, it has been required to automatically identify an observed person without depending on visual observation, and Patent Document 1 (Japanese Unexamined Patent Application, Publication No. 2008-160879) discloses a technique that can satisfy such a requirement. In other words, there is a technique available for extracting and displaying information regarding a subject that is photographed by an observer.

By using the technique disclosed in Patent Document 1, an observed person is photographed with a camera, and communication is performed with a device that is held by the observed person, thereby making it possible to detect the observed person, based on a result of the communication with the device. As a result, by visually confirming conditions of the observed person, the observer perceives the conditions of the observed person thus identified.

However, with the technique disclosed in Patent Document 1, an observed person can be identified, but it has not been easy to grasp information such as conditions of the observed person.

In a case of observing objects other than persons who play sports as well, it has not been easy to grasp information of a predetermined object from among a plurality of objects.

### SUMMARY OF THE INVENTION

An aspect of the present invention is an information processing apparatus, including:

a designation unit that designates an arbitrary area in a real space at arbitrary timing;

an acquisition unit that acquires information regarding an object existing in the real space;

a detection unit that detects an object existing in an area designated by the designation unit at timing designated by the designation unit, among a plurality of objects existing in the real space;

and a selection-display unit that selects and displays information corresponding to the object detected by the detection unit, from among a plurality of pieces of information that can be acquired by the acquisition unit.

Another aspect of the present invention is an information processing method, including:

a designation step of designating an arbitrary area in a real space at arbitrary timing;

an acquisition step of acquiring information regarding an object existing in the real space;

a detection step of detecting an object existing in an area designated in the designation step at timing designated in the designation step, among a plurality of objects existing in the real space;

and a selection-display step of selecting and displaying information corresponding to the object detected in the detection step, from among a plurality of pieces of information that can be acquired in the acquisition step.

Another aspect of the present invention is a non-transitory recording medium having a program stored therein, the program causing a computer to function as:

a designation unit that designates an arbitrary area in a real space at arbitrary timing;

an acquisition unit that acquires information regarding an object existing in the real space;

a detection unit that detects an object existing in an area designated by the designation unit at timing designated by the designation unit, among a plurality of objects existing in the real space;

and a selection-display unit that selects and displays information corresponding to the object detected by the detection unit, from among a plurality of pieces of information that can be acquired by the acquisition unit.

### BRIEF DESCRIPTION OF THE DRAWINGS

FIG. 1 is a diagram showing a schematic configuration of a condition presentation system as an embodiment of an information processing system of the present invention;

FIG. 2 is a diagram showing an example of an image displayed on a display unit of an image capturing apparatus of the condition presentation system shown in FIG. 1;

FIG. 3 is a diagram showing another example of the schematic configuration of the condition presentation system as an embodiment of the information processing system of the present invention;

FIG. 4 is a diagram showing an example of an image displayed on the display unit of the image capturing apparatus of the condition presentation system shown in FIG. 3;

FIG. 5 is a block diagram showing a hardware configuration of the image capturing apparatus according to an embodiment of the present invention;

FIG. 6 is a functional block diagram showing a functional configuration for executing condition presentation processing, in the functional configuration of the image capturing apparatus shown in FIG. 5;

FIG. 7 is a flowchart illustrating a flow of the condition presentation processing that is executed by the image capturing apparatus shown in FIG. 5 having the functional configuration shown in FIG. 6;

FIG. 8 is a diagram showing an image displayed on a display unit of an image capturing apparatus of a condition presentation system in a second embodiment;

FIG. 9 is a flowchart illustrating a flow of condition presentation processing that is executed by the image capturing apparatus in the second embodiment;

FIG. 10 is a diagram showing a schematic configuration of a condition presentation system as an embodiment of an information processing system in a third embodiment;

FIG. 11 is a diagram showing an example of an image displayed on a display unit of the image capturing apparatus of the condition presentation system shown in FIG. 10;

FIG. 12 is a flowchart illustrating a flow of condition presentation processing that is executed by the image capturing apparatus in the third embodiment; and

FIG. 13 is a flowchart illustrating a flow of the condition presentation processing that is executed by a sensor device in the third embodiment.

### DETAILED DESCRIPTION OF THE INVENTION

In the following, first to third embodiments are sequentially and individually described with reference to the drawings, as embodiments of the present invention.

### First Embodiment

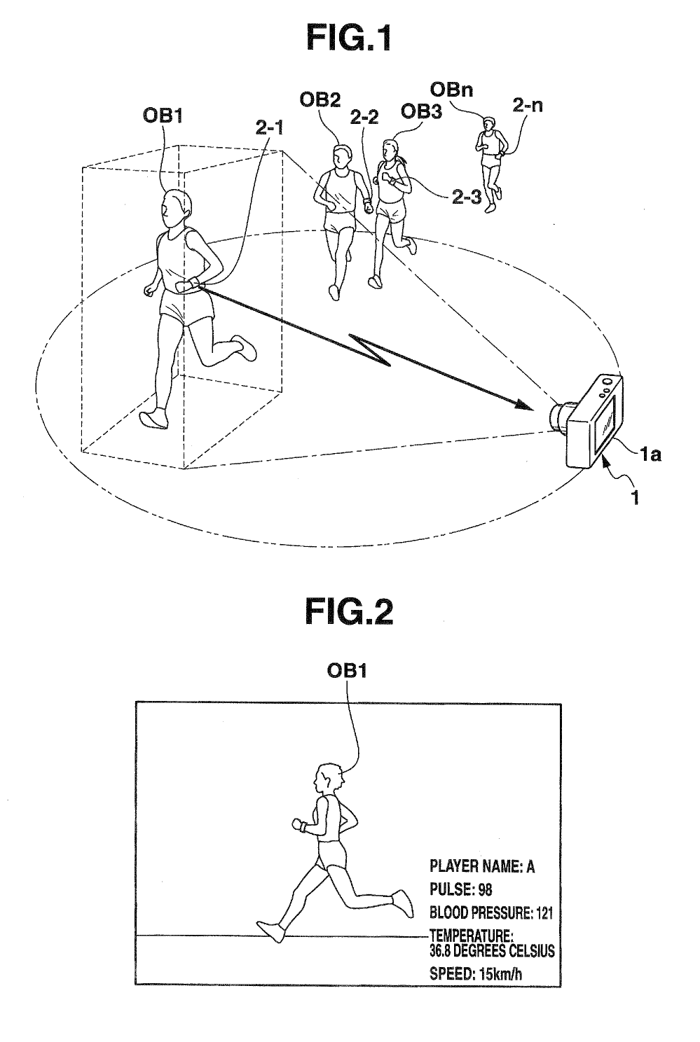

FIG. 1 is a diagram showing a schematic configuration of a condition presentation system as an embodiment of an information processing system of the present invention.

As shown in FIG. 1, the condition presentation system is constructed at a gym or a place where practices and games of team sports, etc. are held, in which the condition presentation system includes an image capturing apparatus 1 carried by an observer (not illustrated), and sensor devices 2-1 to 2-n carried by “n” observed persons OB1 to OBn (n is an arbitrary integer value being at least one), respectively.

In addition to an image capturing function to capture a subject, the image capturing apparatus 1 has at least: a communication function to communicate with each of the sensor devices 2-1 to 2-n; an information processing function to execute a variety of information processing by appropriately using results of such communication; and a display function to display a captured image and an image showing results of the information processing.

More specifically, the image capturing apparatus 1 receives each result of detection by the sensor devices 2-1 to 2-n through the communication function, estimates or identifies various conditions of the observed persons OB1 to OBn, based on the each result of detection through the information processing function, and displays an image showing the various conditions through the display function.

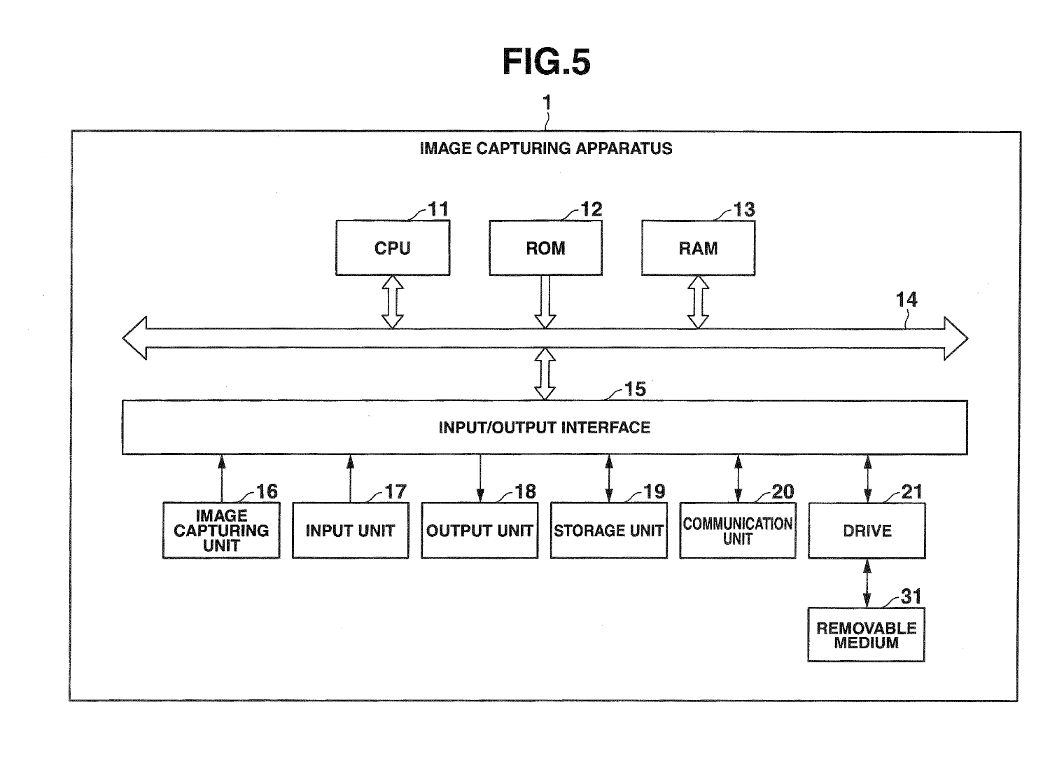

The image capturing apparatus 1 displays an image showing various conditions on a display unit (a single component of an output unit 18 in FIG. 5 to be described below) that is provided to a face 1a (hereinafter referred to as a “rear face 1a”) opposite to a face (hereinafter referred to as a “front face”) on which a lens barrel is disposed.

The image capturing apparatus 1 can display all the various conditions thus estimated or identified on the display unit, and can also selectively display a part of the various conditions on the display unit. For example, the image capturing apparatus 1 can also display conditions of only a selected one of the observed persons OB1 to OBn on the display unit.

In this case, a technique for selecting an observed person OBk as a person whose conditions are displayed (k is an arbitrary integer value from 1 to n) is not limited in particular, but the present embodiment employs a technique for selecting a person, who is included as a subject in a captured image, as the observed person OBk whose conditions are displayed, from among the observed persons OB1 to OBn.

In other words, the observer (not illustrated) displaces the image capturing apparatus 1 such that a person, whose conditions are desired to be displayed from among the observed persons OB1 to OBn, enters an angle of view, and captures an image of the person as a subject through the image capturing function. As a result, data of a captured image that includes the person as the subject is obtained, and the image capturing apparatus 1 identifies the person, who is included as the subject, from the data of the captured image through the information processing function, and selects the person as the observed person OBk whose conditions are displayed.

The image capturing apparatus 1 then estimates or identifies conditions of the observed person OBk, based on a result of detection by a sensor device 2k carried by the observed person OBk, through the information processing function.

The image capturing apparatus 1 then displays an image showing the conditions of the observed person OBk on the display unit through the display function. In this case, the image capturing apparatus 1 may display the image showing the conditions of the observed person OBk so as to be superimposed on the captured image (that may be a live-view image) that includes the observed person OBk as the subject, on the display unit. Here, the “live-view image” refers to a sequence of captured images that are sequentially displayed on the display unit by sequentially reading data of the captured images temporarily recorded in the memory, and this image is also referred to as a through-the-lens image.

More specifically, in the example shown in FIG. 1, the observed persons OB1 to OBn are marathon runners who wear the sensor devices 2-1 to 2-n on their arms or the like, respectively.

The sensor devices 2-1 to 2-n detect contexts per se of the observed persons OB1 to OBn, respectively, or detect physical values allowing estimation or identification of the contexts, and transmit information showing results of such detection, i.e. information about the contexts (hereinafter referred to as “context information”), to the image capturing apparatus 1 via wireless communication.

In the present specification, contexts refer to all of internal conditions and external conditions of the observed persons. Internal conditions of an observed person refer to physical conditions, emotions (feelings or psychological conditions), etc. of the observed person. External conditions of an observed person refer to a spatial or temporal position in which the observed person exists (the temporal position refers to, for example, the current time), and also refer to predetermined conditions that are distributed in spatial or temporal directions around the observed person (or predetermined conditions that are distributed in both directions).

In the following descriptions, in a case in which the sensor devices 2-1 to 2-n are not required to be individually distinguished, the sensor devices 2-1 to 2-n are collectively and simply referred to as the “sensor devices 2”. In a case in which the sensor devices 2 are described as such, the suffixes -1 to -n of the reference numeral 2 are omitted.

The sensor devices 2 also refer to a sensor group that is composed of not only a sensor that detects a single context or the like, but also a single sensor that detects two or more contexts, and two or more sensors (detectable types and number of contexts are not limited).

More specifically, for example, as a sensor that detects external contexts, it is possible to employ a GPS (Global Positioning System) that detects current positional information of an observed person, a clock that measures (detects) the current time, a wireless communication device that detects persons and objects around an observed person, etc. For example, as sensors that detect internal contexts, it is possible to employ sensors that detect a pulse, a respiration rate, perspiration, pupillary opening, a degree of fatigue, an amount of exercise, etc.

In the example shown FIG. 1, an area indicated with a two-dot chain line is a range for receiving context information from the sensor devices 2, and the image capturing apparatus 1 receives context information from each of the sensor devices 2-1, 2-2 and 2-3 that exist within the range.

However, the image capturing apparatus 1 captures an image of a real space indicated with a chain line, which is within a range of an angle of view (within an image capturing range), recognizes the observed person OB1 as a main subject from data of a captured image thus obtained, and selects the observed person OB1 as a person whose contexts are displayed.

The image capturing apparatus 1 displays the image showing the contexts of the observed person OB1 (hereinafter referred to as a “context image”) on the display unit.

FIG. 2 shows an example of a context image that is displayed on the display unit in this manner.

As shown in FIG. 2, the context image of the observed person OB1 is displayed so as to be superimposed on the captured image (which may be a live-view image) showing the observed person OB1.

The context image of the observed person OB1 includes a name “A” as information for identifying the observed person OB1. The contexts of the observed person OB1 include a pulse “98 (bpm)”, a blood pressure “121 (mmHg)”, a temperature “36.8 degrees Celsius”, and a speed “15 km/h”.

By visually recognizing the context image displayed on the display unit of the image capturing apparatus 1 as shown in FIG. 2, the observer can visually recognize the captured image showing the observed person OB1 as well as character information indicating the contexts of the observed person OB1, and can appropriately grasp the contexts of the observed person OB1, based on a result of such visual recognition.

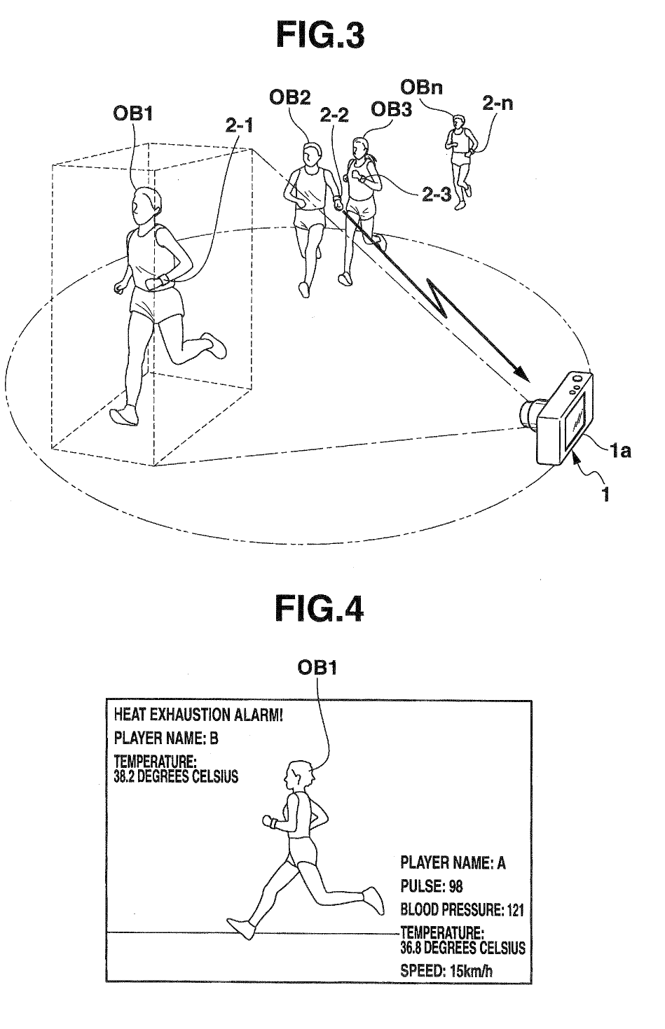

FIG. 3 is a diagram showing another example of the schematic configuration of the condition presentation system as an embodiment of the information processing system of the present invention.

More specifically, in the example shown in FIG. 3, each of the sensor devices 2-1 to 2-n transmits context information to the image capturing apparatus 1 via wireless communication, similarly to the example shown in FIG. 1.

The image capturing apparatus 1 recognizes the observed person OB1 as a main subject from data of the captured image thus obtained, and selects the observed person OB1 as a person whose contexts are displayed.

In this case, in addition to the observed person OB1 as the main subject recognized from the data of the captured image, the image capturing apparatus 1 also recognizes and selects an observed person, whose condition is abnormal, as a person whose contexts are displayed.

The image capturing apparatus 1 displays a context image of the observed person OB1 on the display unit.

FIG. 4 shows an example of a context image that is displayed on the display unit in this manner.

As shown in FIG. 4, the context image of the observed person OB1 is displayed so as to be superimposed on the captured image (which may be a live-view image) showing the observed person OB1.

The context image of the observed person OB1 includes a name “B” as information for identifying an abnormal observed person OB2. The contexts of the abnormal observed person OB2a include temperature “38 degrees Celsius”, and an alerting message “Heat Exhaustion Alarm!”.

By visually recognizing the context image displayed on the display unit of the image capturing apparatus 1 as shown in FIG. 4, the observer can visually recognize the captured image showing the observed person OB1 as well as character information indicating the context of the abnormal observed person OB2, and can appropriately grasp the abnormal observed person OB2, based on results of such visual recognition.

The condition presentation system configured with the above concept has a function capable of easily grasping conditions of a predetermined observed person from among a plurality of observed persons.

The condition presentation system having the above function includes the image capturing apparatus 1 and the plurality of sensor devices 2-1 to 2-n.

The image capturing apparatus 1 receives context information from the plurality of sensor devices 2-1 to 2-n. The image capturing apparatus 1 has a function to present context information of an observed person OB, who appears within the image capturing range, to the user via the display unit or the like, based on the context information received from the sensor devices 2-1 to 2-n.

On the other hand, the sensor devices 2, which are worn on the observed persons OB whose conditions are desired to be grasped, detect conditions of the observed persons (objects) as context information, and have a function to transmit the context information thus detected to the image capturing apparatus 1.

FIG. 5 is a block diagram showing a hardware configuration of the image capturing apparatus 1 according to an embodiment of the present invention.

The image capturing apparatus 1 is configured as, for example, a digital camera.

The image capturing apparatus 1 includes a CPU (Central Processing Unit) 11, ROM (Read Only Memory) 12, RAM (Random Access Memory) 13, a bus 14, an input/output interface 15, an image capturing unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capturing unit, the input unit 17, the output unit 18, the storage unit 19, the communication unit 20, and the drive 21 are connected to the input/output interface 15.

The image capturing unit 16 includes an optical lens unit and an image sensor, which are not illustrated.

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capturing unit 16.

Such an output signal of the image capturing unit 16 is hereinafter referred to as “data of a captured image”. Data of a captured image is supplied to the CPU 11 as appropriate.

The input unit 17 is configured by various buttons and the like, and inputs a variety of information in accordance with instruction operations by the user.

The output unit 18 is configured by the display unit, the sound output unit and the like, and outputs images and sound.

The storage unit 19 is configured by DRAM (Dynamic Random Access Memory) or the like, and stores data of various images.

The communication unit 20 controls communication with other devices (not shown) via networks including a wireless LAN (Local Area Network) and the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

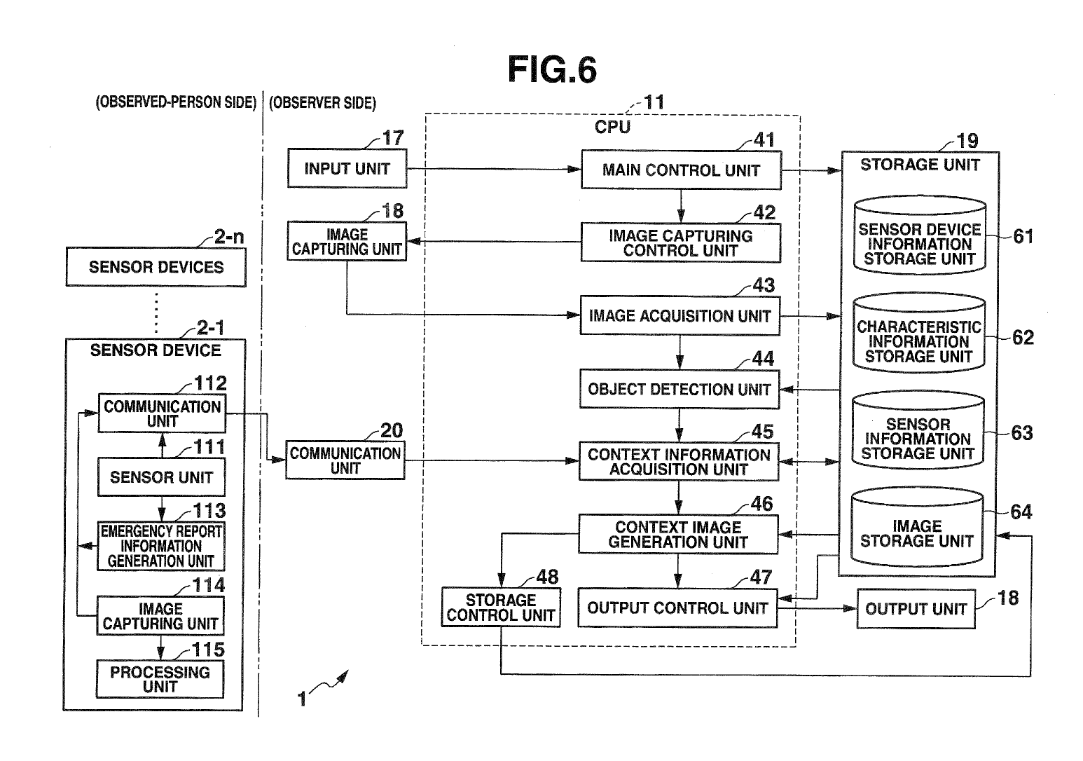

FIG. 6 is a functional block diagram showing a functional configuration for executing condition presentation processing, in the functional configuration of the image capturing apparatus 1 as such.

The condition presentation processing refers to a sequence of processing, in which context information corresponding to an observed person OB is displayed as an output for presenting conditions of the observed person OB being an object detected in a captured image, from among context information acquired from the plurality of sensor devices 2-n.

As shown in FIG. 6, a main control unit 41, an image capturing control unit 42, an image acquisition unit 43, an object detection unit 44, a context information acquisition unit 45, a context image generation unit 46, an output control unit 47, and a storage control unit 48 function, when the image capturing apparatus 1 executes the condition presentation processing.

A sensor device information storage unit 61, a characteristic information storage unit 62, a context information storage unit 63, and an image storage unit 64 are provided as an area of the storage unit 19. The sensor device information storage unit 61 to the image storage unit 64 (the units 61, 62, 63 and 64) are provided as an area of the storage unit 19, but those units may be provided as, for example, another area such as an area of the removable medium 31.

The sensor device information storage unit 61 stores sensor device information. Sensor device information is information that allows a sensor device to be identified based on context information transmitted from any of the sensor devices 2-n, and is information of an observed person who wears the sensor device (more specifically, information of a name of the observed person).

The characteristic information storage unit 62 stores characteristic information. Characteristic information refers to characteristic information that allows identification of an observed person OB included in data of a captured image. More specifically, in the present embodiment, information indicating a number tag of an observed person, and information of a face (data of a face image) of an observed person are employed as characteristic information. In other words, characteristic information that is stored in the characteristic information storage unit 62 is data of the number tags and the face images of the observed persons OB corresponding to the sensor devices 2-n, respectively.

The context information storage unit 63 stores context information acquired from the sensor devices 2, and stores information that is to be compared with the context information (a threshold value for determining a status) for the purpose of determining a condition of a status of an observed person, based on the context information thus acquired.

The image storage unit 64 stores data of various images such as a captured image and a context image that is synthesized from the captured image and context information.

The main control unit 41 executes a variety of processing that includes processing of implementing various multi-purpose functions.

In response to an input operation by the user via the input unit 17, the image capturing control unit 42 controls image capturing operations of the image capturing unit 16.

The image acquisition unit 43 acquires data of a captured image that is captured by the image capturing unit 16.

The object detection unit 44 detects characteristic information by analyzing the captured image thus acquired. In other words, the object detection unit 44 detects information serving as characteristic information such as a face and a number tag of a person, based on subjects that appear in the captured image.

The object detection unit 44 determines whether the information thus detected coincides with characteristic information stored in the characteristic information storage unit 62.

Eventually, the object detection unit 44 detects an observed person OB as an object, based on such coinciding characteristic information stored in the characteristic information storage unit 62.

The context information acquisition unit 45 receives and acquires context information transmitted from the sensor devices 2. The context information acquisition unit 45 causes the context information storage unit 63 to store the context information thus received.

The context information acquisition unit 45 selectively acquires context information of the sensor devices 2 corresponding to characteristic information stored in the characteristic information storage unit 62, by way of the object detection unit 44.

The context information acquisition unit 45 determines a value of the context information thus acquired. In other words, the context information acquisition unit 45 determines conditions included in the context information thus acquired. When making a determination, the context information acquisition unit 45 makes comparisons with reference values such as an upper limit, a lower limit, an ordinary range, an abnormal range, and an alert range, of the context information.

Based on the context information and the information of the corresponding sensor device 2, the context image generation unit 46 generates data of a context image, in which the context information thus acquired can be transparently displayed on the data of the captured image, or generates data of a context image that is synthesized by superimposing the context information on the captured image.

The output control unit 47 controls the output unit 18 to display, as an output thereof, the data of the context image thus generated.

The storage control unit 48 controls the image storage unit 64 to store the data of the context image thus generated.

On the other hand, the sensor devices 2 at least have a function capable of detecting context information by sensing conditions of the observed persons OB who wear the sensor devices 2, and have a function capable of transmitting the context information thus detected to the image capturing apparatus 1.

The sensor devices 2 as such include a sensor unit 111, a communication unit 112, an emergency report information generation unit 113, an image capturing unit 114, and a processing unit 115.

The sensor devices 2 are configured as wearable devices that can be carried or worn by the observed persons OB, or are configured as devices that can be attached to accessories such as a number tag, a badge, and a hat.

The sensor unit 111 is configured by various sensors such as: a GPS position sensor capable of pinpointing a position of the device itself; a biogenic sensor capable of measuring a heartbeat, a temperature, a degree of fatigue, an amount of exercise, etc.; a 3-axis acceleration sensor/angular velocity sensor (gyro sensor) capable of measuring a speed and a direction of movement; a step sensor; a vibration sensor; and a kinetic state sensor such as a Doppler velocity sensor.

The communication unit 112 controls communication with the image capturing apparatus 1 through networks including a wireless LAN and the Internet. The communication unit 112 transmits context information that is intermittently or periodically detected.

In a case in which contents of the context information thus detected are abnormal, the emergency report information generation unit 113 generates information for reporting such abnormality as an emergency report. The emergency report information generation unit 113 will be described in detail in a second embodiment.

The image capturing unit 114 is configured so as to be capable of capturing a whole sky (panoramic) moving image. The image capturing unit 114 will be described in detail in a third embodiment.

The processing unit 115 executes image processing such as image correction, and executes a variety of processing including processing of implementing a various multi-purpose functions of the sensor devices 2. The processing unit 115 will be described in detail in the third embodiment.

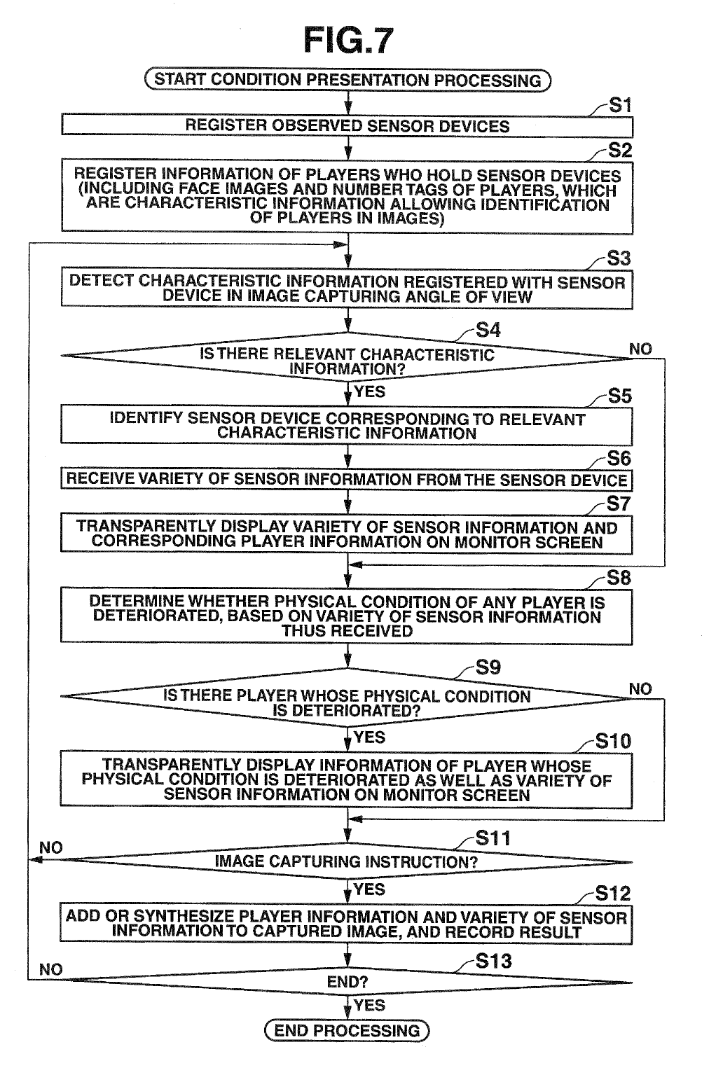

Next, descriptions are provided for a flow of the condition presentation processing that is executed by the image capturing apparatus 1 as configured above. FIG. 7 is a flowchart illustrating a flow of the condition presentation processing that is executed by the image capturing apparatus 1 shown in FIG. 5 having the functional configuration shown in FIG. 6.

The condition presentation processing is initiated by the user's operation for initiating the condition presentation processing via the input unit 17.

In Step S1, the main control unit 41 registers the sensor devices 2-n to be observed. More specifically, in response to the user's operation for registering the sensor devices 2-n via the input unit 17, the main control unit 41 controls the sensor device information storage unit 61 to store information of the sensor devices 2-n to be registered.

In Step S2, the main control unit 41 registers information of players (observed persons) who carry the sensor devices 2-n, respectively. More specifically, in response to the user's operation for registering information of the players (the observed persons) via the input unit 17, the main control unit 41 controls the characteristic information storage unit 62 to store the information of the players (the observed persons) to be registered.

More specifically, data to be used as information of the players (the observed persons) is image data of faces the players (the observed persons), and data of number tags of the players (the observed persons), which are characteristic information that allows identification of the players (the observed persons) in the image.

In Step S3, the object detection unit 44 detects characteristic information registered for each of the sensor devices 2-n within an image capturing angle of view. More specifically, the object detection unit 44 detects faces and number tags of persons as characteristic information in the captured image.

In Step S4, the object detection unit 44 determines whether there is relevant characteristic information. More specifically, the object detection unit 44 determines whether there is relevant characteristic information, by comparing the characteristic information thus acquired, with the characteristic information stored in the characteristic information storage unit 62.

In a case in which there is no relevant characteristic information, the determination in Step S4 is NO, and the processing advances to Step S8. The processing in and after Step S8 will be described later.

In a case in which there is relevant characteristic information, the determination in Step S4 is YES, and the processing advances to Step S5.

In Step S5, the object detection unit 44 identifies a sensor device 2 corresponding to the relevant characteristic information. More specifically, based on the characteristic information thus determined, the object detection unit 44 identifies a sensor device 2 from the sensor device information stored in the sensor device information storage unit 61.

In Step S6, the context information acquisition unit 45 receives a variety of context information from the corresponding sensor device 2. More specifically, from among the context information transmitted from the sensor devices 2, the context information acquisition unit 45 selectively receives the context information transmitted from the corresponding sensor device.

In Step S7, the output unit 18 transparently displays the variety of context information thus received, together with corresponding player information, on the screen. More specifically, context images are generated from the variety of context information thus received, and the output control unit 47 controls the output unit 18 to transparently display the context images on the captured image.

In this case, the context image generation unit 46 generates data of the various context images that are transparently displayed, based on the context information stored in the context information storage unit 63.

As a result, the output unit 18 displays an image in which, for example, the context images are transparently displayed on the captured image as shown in FIG. 2,

In Step S8, the context information acquisition unit 45 determines whether a physical condition of the players (the observed persons) is deteriorated, based on the variety of context information thus received. More specifically, in a case in which an abnormal value indicating deterioration of a physical condition is extracted from the variety of context information thus received, the context information acquisition unit 45 determines that the physical condition of the player (the observed person) is deteriorated.

In Step S9, the context information acquisition unit 45 determines whether there is a player whose physical condition is deteriorated. More specifically, in a case in which an abnormal value indicating deterioration of a physical condition is extracted in Step S8, the context information acquisition unit 45 determines that there is a player whose physical condition is deteriorated.

In a case in which it is determined that there is no player whose physical condition is deteriorated, the determination in Step S9 is NO, and the processing advances to Step S11. The processing in and after Step S11 will be described later.

In a case in which it is determined that there is a player whose physical condition is deteriorated, the determination in Step S9 is YES, and the processing advances to Step S10.

In Step S10, the output unit 18 transparently displays player information of the player whose physical condition is deteriorated, together with the variety of context information, on the screen. More specifically, the output control unit 47 controls the output unit 18 to transparently display the player information of the player whose physical condition is deteriorated, and the variety of context information, on the captured image.

As a result, the output unit 18 displays an output of, for example, the image data as shown in FIG. 4.

In Step S11, the main control unit 41 determines whether there was an image capturing instruction.

More specifically, as the image capturing instruction, the main control unit 41 determines whether the user performed an image capturing instruction operation.

In a case in which there was not an image capturing instruction, the determination in Step S11 is NO, and the processing returns to Step S3.

In a case in which there was an image capturing instruction, the determination in Step S11 is YES, and the processing advances to Step S12.

In Step S12, the storage control unit 48 synthesizes the player and the variety of context information to the captured image, and records a result. More specifically, the storage control unit 48 controls the image storage unit 64 to store the captured image data, in which the player and the variety of context information are synthesized. In this case, the context image generation unit 46 generates context image data by synthesizing the player and the variety of context information to the captured image data. The storage control unit 48 controls the image storage unit 64 to store the data of the context image thus generated.

In Step S13, the main control unit 41 determines whether the processing is terminated. More specifically, the main control unit 41 determines whether the user performed a terminating operation.

In a case in which the processing was not terminated, i.e. there was not a terminating operation, the determination in Step S13 is NO, and the processing returns to Step S3.

In a case in which the processing was terminated, i.e. there was a terminating operation, the determination in Step S13 is YES, and the condition presentation processing is terminated.

### Second Embodiment

In the first embodiment, internal conditions are mainly displayed as an output of a context image; however, the displaying of an output is not limited in particular to the example in the first embodiment, but an output can be displayed in an arbitrary manner of displaying.

Accordingly, in a second embodiment, external conditions are displayed in a context image, and in particular, external conditions in a spatial position where an observed person exists are displayed in a context image.

By using GPS positional information among the context information received, the image capturing apparatus 1 generates and displays an image as a context image, in which an observed person is arranged on a map.

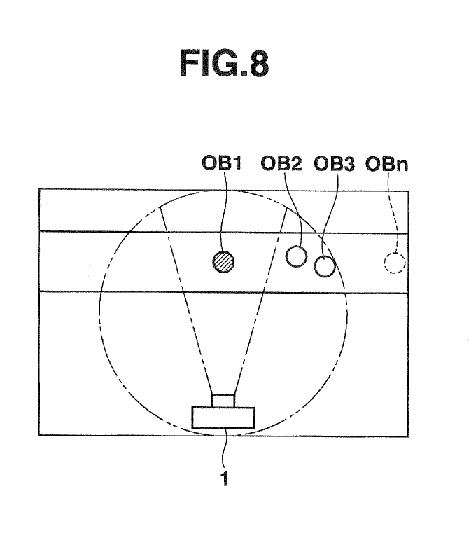

FIG. 8 is a diagram showing another example of an image displayed on the display unit of the image capturing apparatus of the condition presentation system shown in FIG. 1.

In the example shown in FIG. 8, the context image is configured as an image, in which the observed persons OB1 to OB3 are arranged on a predetermined map correspondingly to the context information received. This context image is sequentially updated based on the context information received, and is displayed as an output of an image showing current positions. In other words, when an observed person OB moves, the context image being displayed is changed.

In the example shown FIG. 8, an area indicated with a two-dot chain line is a range for receiving context information from the sensor devices 2, and the image capturing apparatus 1 receives context information from each of the sensor devices 2-1, 2-2 and 2-3 that exist within the range. In the example shown in FIG. 8, the observed person OB1 within the image capturing range is indicated with a shaded circle, and the observed persons OB2 and OB3 being outside the image capturing range are indicated with blank circles. For convenience, the observed person OBn whose context information is not received is indicated with a dashed circle.

More specifically, in the image capturing apparatus 1, the main control unit 41 acquires map image information and positional information of the apparatus itself.

The sensor devices 2 acquire context information including GPS values acquired via the sensor unit 111, and transmit the context information via the communication unit 112.

The image capturing apparatus 1 receives context information, then generates data of a context image, in which the map image information includes the context information with a type of displaying such as indication of whether a sensor device is within the image capturing range based on the position of the apparatus itself, and subsequently displays the context image as an output. As a result, the image capturing apparatus 1 displays a context image as shown in FIG. 8.

In the first embodiment, the image capturing apparatus 1 determines context information received, and displays a player (an observed person) who is outside the image capturing range, and whose physical condition is deteriorated, as an output; whereas, in the second embodiment, the image capturing apparatus 1 determines a context detected, and in a case in which an abnormal context is detected, a sensor device 2 transmits an emergency report to the image capturing apparatus 1.

More specifically, the sensor devices 2 further include the emergency report information generation unit 113 as shown in FIG. 6.

The emergency report information generation unit 113 determines context information acquired via the sensor unit 111, and in a case in which the context information is determined to be abnormal, the emergency report information generation unit 113 generates an emergency report information including information such as emergency, the context information, and a name of the corresponding observed person OB. The emergency report information generated by the emergency report information generation unit 113 is transmitted to the image capturing apparatus 1 via the communication unit 112.

The image capturing apparatus 1 receives the emergency report information, then acquires a position of the apparatus itself and map information, and displays the context information and the name of corresponding observed person OB as an output.

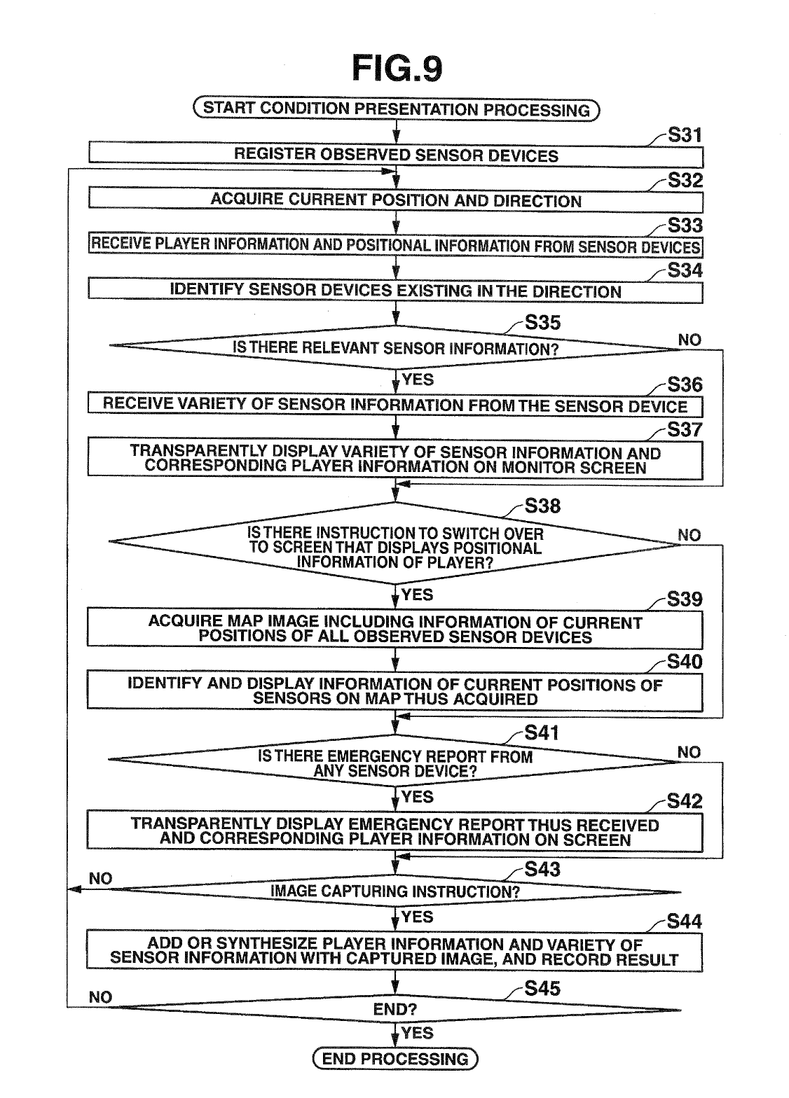

FIG. 9 is a flowchart illustrating another example of a flow of the condition presentation processing executed by the image capturing apparatus shown in FIG. 5 having the functional configuration shown in FIG. 6.

In Step S31, the main control unit 41 registers the sensor devices 2-n to be observed. More specifically, in response to the user's operation for registering the sensor devices 2-n via the input unit 17, the main control unit 41 controls the sensor device information storage unit 61 to store information of the sensor devices to be registered.

In Step S32, the main control unit 41 acquires a current position of the apparatus itself and an image capturing direction.

In Step S33, the context information acquisition unit 45 acquires player information (names) and positional information of the players (the observed persons OB) from the sensor devices 2-n, respectively. More specifically, the context information acquisition unit 45 receives context information including GPS values acquired by the sensor units 111 of the sensor devices 2-n.

In Step S34, based on the current position of the apparatus itself and the image capturing direction, the object detection unit 44 identifies the sensor devices 2 existing in the image capturing direction.

In Step S35, the object detection unit 44 determines whether there is a relevant sensor device 2. More specifically, the object detection unit 44 determines whether there is a sensor device 2 existing in the image capturing direction.

In a case in which there is not a corresponding sensor device 2, the determination in Step S35 is NO, and the processing advances to Step S38. The processing in and after Step S38 will be described later.

In a case in which there is a corresponding sensor device 2, the determination in Step S35 is YES, and the processing advances to Step S36.

In Step S36, the context information acquisition unit 45 receives a variety of context information from the corresponding sensor device 2. More specifically, from among the context information transmitted from the sensor devices 2, the context information acquisition unit 45 selectively receives the context information transmitted from the corresponding sensor device 2.

In Step S37, the output unit 18 transparently displays the variety of context information thus received, together with corresponding player information, on the screen. More specifically, context images are generated from the variety of context information thus received, and the output control unit 47 controls the output unit 18 to transparently display the context images on the captured image. As a result, the output unit 18 displays an output of, for example, the image data as shown in FIG. 2.

In Step S38, the main control unit 41 determines whether there was an instruction to switch over to a “player position display screen”. More specifically, the main control unit 41 determines whether the user performed an operation to switch over to the “player position display screen” via the input unit 17. The “player position display screen” is a screen that schematically displays the positions of the players (the observed persons) arranged on the map as shown in FIG. 8.

In a case in which there was not an instruction to switch over to the “player position display screen”, the determination in Step S38 is NO, and the processing advances to Step S41. The processing in and after Step S41 will be described later.

In a case in which there was an instruction to switch over to the “player position display screen”, the determination in Step S38 is YES, and the processing advances to Step S39.

In Step S39, the main control unit 41 acquires a map image including current positions received from all the sensor devices 2-n.

In Step S40, the output unit 18 displays the current positions identified for the sensor devices 2-n on the map image thus acquired. More specifically, the output control unit 47 controls the output unit 18 to plot the current positions of the sensor devices 2 in corresponding positions on the map image, and to display the map as an output. As a result, the output unit 18 displays an image as shown in FIG. 8 as an output.

In this case, a player (an observed person) located in the image capturing direction is displayed by being highlighted or the like so as to be distinguishable from the other players. Such a player is indicated with the shaded circle in the example shown in FIG. 9.

In Step S41, the context information acquisition unit 45 determines whether there was an emergency report from any of the sensor devices 2. More specifically, the context information acquisition unit 45 determines whether emergency report information is included in the context information thus received.

In a case in which there was not an emergency report from any of the sensor devices 2, the determination in Step S41 is NO, and the processing advances to Step S43. The processing in and after Step S43 will be described later.

In a case in which there was an emergency report from any of the sensor devices 2, the determination in Step S41 is YES, and the processing advances to Step S42.

In Step S42, the output unit 18 transparently displays the emergency report thus received, together with information of a corresponding player (observed person), on the screen. More specifically, context images are generated from the context information including the emergency report information thus received, and the output control unit 47 controls the output unit 18 to transparently display the context images on the captured image.

In Step S43, the main control unit 41 determines whether there was an image capturing instruction.

More specifically, as the image capturing instruction, the main control unit 41 determines whether the user performed an image capturing instruction operation.

In a case in which there was not an image capturing instruction, the determination in Step S43 is NO, and the processing returns to Step S32.

In a case in which there was an image capturing instruction, the determination in Step S43 is YES, and the processing advances to Step S44.

In Step S44, the storage control unit 48 synthesizes the player and the variety of context information to the captured image, and records a result. More specifically, the storage control unit 48 controls the image storage unit 64 to store the captured image data, in which the player and the variety of context information are synthesized. In this case, the context image generation unit 46 generates context image data by synthesizing the player and the variety of context information to the captured image data. As a result, the storage control unit 48 controls the image storage unit 64 to store data of the context image generated by the context image generation unit 46.

In Step S45, the main control unit 41 determines whether the processing is terminated. More specifically, the main control unit 41 determines whether the user performed a terminating operation.

In a case in which the processing was not terminated, i.e. there was not a terminating operation, the determination in Step S45 is NO, and the processing returns to Step S32.

In a case in which the processing was terminated, i.e. there was a terminating operation, the determination in Step S45 is YES, and the condition presentation processing is terminated.

### Third Embodiment

In the first embodiment, internal conditions are mainly displayed as an output of a context image; however, the displaying of an output is not limited in particular to the example in the first embodiment, but an output can be displayed in an arbitrary manner of displaying.

Accordingly, in the third embodiment, external conditions are displayed, and in particular, conditions around an observed person are displayed in a context image. In other words, the context image in the third embodiment is a surrounding image displayed as conditions around an observed person.

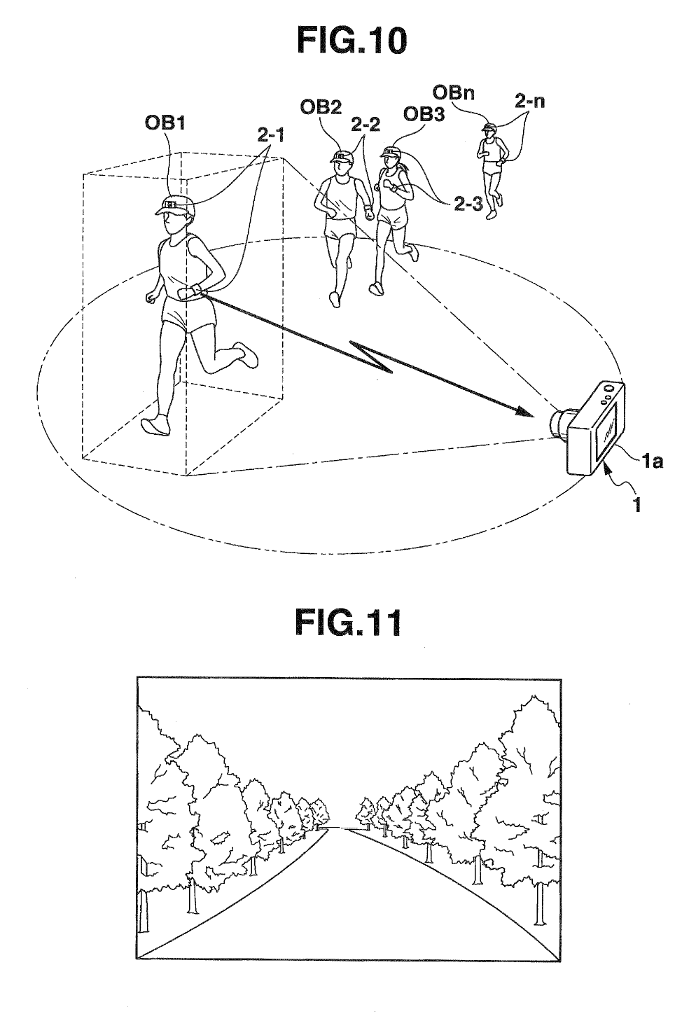

FIG. 10 is a diagram showing another example of the schematic configuration of the condition presentation system as an embodiment of the information processing system of the present invention.

In the example shown in FIG. 10, in addition to the sensor units 111 worn on the arms of the observed persons, the image capturing units 114 worn on the heads of the observed persons generate data of images that capture conditions around the observed persons.

More specifically, as shown in FIG. 6, data of an image is generated by the functioning of the image capturing unit 114 and the processing unit 115 in the sensor device 2.

The image capturing unit 114 is configured so as to be capable of capturing a panoramic (whole sky) moving image, and is worn on the head of the observed person.

In the present example, since the observed person is running, captured image data needs to be corrected in accordance with the running condition; therefore, the processing unit 115 executes camera shake correction to cancel only a moving component corresponding to the movement of the observed person from the change in the angle of view.

In order to identify a cycle for cancelling the camera shake as described above, the processing unit 115 identifies a cycle of movement of the observed person, based on a cycle of acceleration, by using acceleration detected by the sensor unit 111.

The sensor unit 111 detects acceleration, and detects a direction from a viewpoint of the observed person, in order to display a state of view from the observed person, based on the moving image generated, of which camera shake was corrected.

The sensor device 2 configured as above corrects the camera shake of the data of the moving image captured by the image capturing unit 114, and transmits the data of the moving image, together with information of the direction from the viewpoint of the observed person, to the image capturing apparatus 1 via the communication unit 112.

As a result, the image capturing apparatus 1 displays the received data of the moving image as an output, and also displays the data of the moving image from the viewpoint of the observed person as an arbitrary viewpoint, as an output.

The image capturing apparatus 1 displays a context image including an image captured by the observed person OB1 on the display unit.

FIG. 11 is a diagram showing an example of an image displayed on the display unit of the image capturing apparatus 1 of the condition presentation system shown in FIG. 10.

As in the example shown in FIG. 11, the image capturing apparatus 1 displays a captured image that is ahead of the observed person.

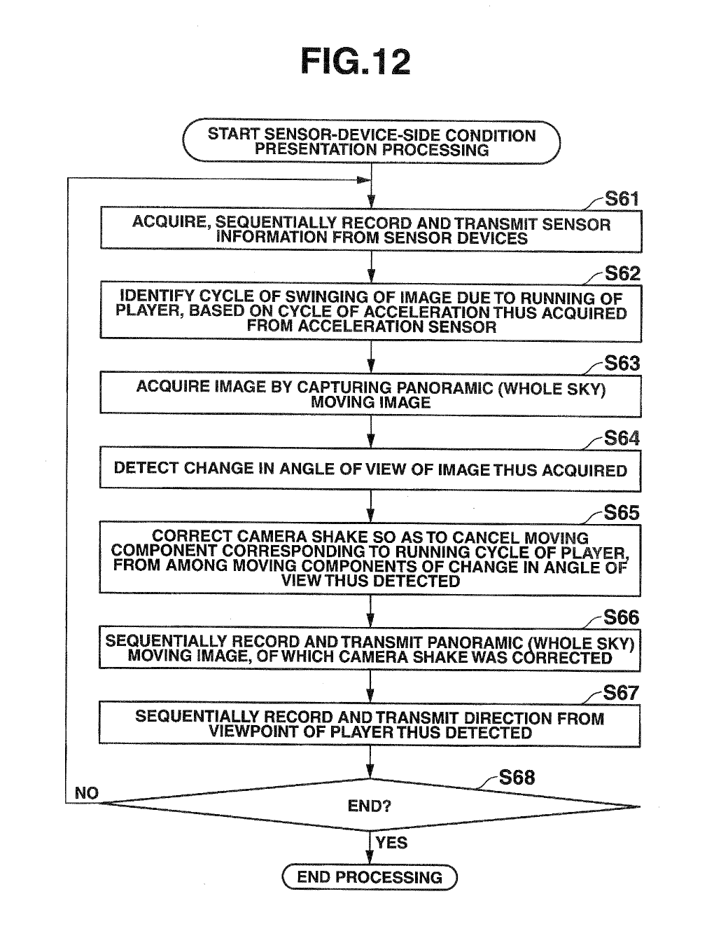

FIG. 12 is a flowchart showing another example of a flow of the condition presentation processing (sensor-device-side condition presentation processing) that is executed by the sensor device 2 having the functional configuration shown in FIG. 6.

In Step S61, the sensor unit 111 acquires context information regarding acceleration, and sequentially records and transmits the context information. More specifically, the sensor unit 111 sequentially acquires information of acceleration, and transmits the information to the image capturing unit 114.

In Step S62, based on the cycle of acceleration thus acquired, the image capturing unit 114 identifies a cycle of the swinging of the image due to the running (movement) of the player (the observed person).

In Step S63, the image capturing unit 114 acquires a moving image by capturing a panoramic (whole sky) moving image.

In Step S64, the processing unit 115 detects change in the angle of view of the image thus acquired.

In Step S65, the processing unit 115 corrects camera shake to cancel only a moving component corresponding to the cycle of the running (movement) of the player (the observed person), from among the moving components of the change in the angle of view thus detected.

In Step S66, the communication unit 112 sequentially records and transmits the panoramic (whole sky) moving image, of which camera shake was corrected.

In Step S67, the communication unit 112 sequentially records and transmits the direction from the viewpoint of the player (the observed person) detected by the sensor unit 111.

In Step S68, the processing unit 115 determines whether the processing is terminated. More specifically, the main control unit 41 determines whether the user performed a terminating operation.

In a case in which the processing was not terminated, i.e. there was not a terminating operation, the determination in Step S68 is NO, and the processing returns to Step S61.

In a case in which the processing was terminated, i.e. there was a terminating operation, the determination in Step S45 is YES, and the sensor-device-side condition presentation processing is terminated.

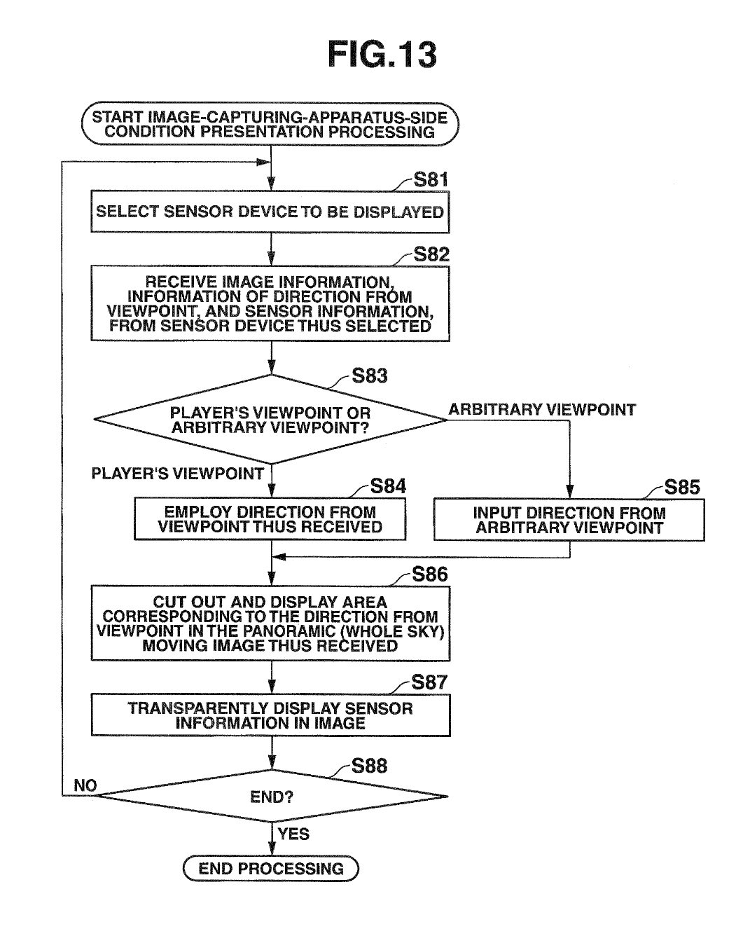

FIG. 13 is a flowchart showing another example of a flow of the condition presentation processing (image-capturing-apparatus-side condition presentation processing) that is executed by the image capturing apparatus 1 shown in FIG. 5 having the functional configuration shown in FIG. 6.

In Step S81, the main control unit 41 selects a sensor device 2 to be displayed. More specifically, by the user's selection operation via the input unit 17, the main control unit 41 selects a predetermined sensor device 2 from among the sensor devices 2 that can be displayed, based on the context information thus acquired.

In Step S82, the context information acquisition unit 45 receives the context information from the sensor device 2 thus selected. More specifically, the context information acquisition unit 45 receives the data of the moving image of which camera shake was corrected, the information of the direction from the viewpoint, and other context information, from the sensor device 2 thus selected.

In Step S83, the main control unit 41 determines whether the player's viewpoint or an arbitrary viewpoint should be selected. More specifically, by the user's selection operation, the main control unit 41 selects a display image from the player's viewpoint or a display image from an arbitrary viewpoint.

In a case in which the player's viewpoint is selected, the processing advances to Step S84.

In Step S84, the main control unit 41 employs the direction from the viewpoint thus received. Subsequently, the processing advances to Step S86.

On the other hand, in a case in which an arbitrary viewpoint is selected, the processing advances to Step S85.

In Step S85, the main control unit 41 inputs a direction from an arbitrary viewpoint. More specifically, based on the user's operation for designating a direction from a viewpoint via the input unit 17, the main control unit 41 determines a direction from an arbitrary viewpoint.

In Step S86, the output unit 18 cuts out an area corresponding to the direction from the viewpoint in the panoramic (whole sky) moving image thus received, and displays the area as an output.

In Step S87, the output unit 18 transparently displays the context information in the moving image that was cut out.

In Step S88, the main control unit 41 determines whether the processing is terminated. More specifically, the main control unit 41 determines whether the user performed a terminating operation.

In a case in which the processing was not terminated, i.e. there was not a terminating operation, the determination in Step S88 is NO, and the processing returns to Step S81.

In a case in which the processing was terminated, i.e. there was a terminating operation, the determination in Step S88 is YES, and the image-capturing-apparatus-side condition presentation processing is terminated.

Therefore, the condition presentation system is capable of easily grasping conditions of a predetermined observed person from among a plurality of observed persons.

The image capturing apparatus 1 as configured above includes the object detection unit 44, the context information acquisition unit 45, and the output control unit 47.

The object detection unit 44 detects an object that enters a predetermined area in a real space, among a plurality of objects.

The context information acquisition unit 45 acquires context information regarding contexts of the plurality of objects.

The control output control unit 47 executes control such that, among a plurality of pieces of context information that can be acquired, context information corresponding to the object detected by the object detection unit 44 is selected and displayed as an output.

Therefore, among a plurality of pieces of context information thus acquired, the image capturing apparatus 1 selects the context information corresponding to the object detected by the object detection unit 44, and outputs the context information corresponding to the object selected by the context information acquisition unit 45.

Therefore, it is possible to easily grasp conditions of a predetermined object from among a plurality of objects (observed persons in the present embodiment).

The context information acquisition unit 45 acquires context information regarding contexts of the objects from the sensors attached to the plurality of objects.

Therefore, the image capturing apparatus 1 can acquire context information of a plurality of objects identified.

The object detection unit 44 detects a person, who enters a predetermined area in a real space, as an object.

The context information acquisition unit 45 acquires context information regarding internal conditions of persons, from the sensors worn on the plurality of persons.

Therefore, the image capturing apparatus 1 can acquire context information regarding internal conditions (for example, a pulse) of a person thus detected.

The image capturing apparatus 1 includes the image capturing unit 16.

The image capturing unit 16 captures an image of an arbitrary area in a real space.

The output unit 18 displays data of the image captured by the image capturing unit 16 as an output.

The object detection unit 44 sequentially detects an object that enters a predetermined area in a real space corresponding to the image capturing direction of the image capturing unit 16.

The output control unit 47 sequentially selects context information corresponding to an object sequentially detected by the object detection unit 44, and sequentially displays the context information on the output unit 18 as an output.

Accordingly, simply by capturing an image of an object, the image capturing apparatus 1 can designate the object to be selected; therefore, it is possible to simply and intuitively grasp conditions of a predetermined object from among a plurality of objects (observed persons in the present embodiment).

The output control unit 47 synthesizes sequentially selected context information with captured image data, and sequentially displays a result on the output unit 18.

Therefore, the image capturing apparatus 1 can concurrently confirm external appearance information and context information of an object.

The object detection unit 44 detects an object that enters an image capturing angle of view of the image capturing unit 16, based on a characteristic in terms of the image of the object, in data of the image captured by the image capturing unit 16.

Therefore, the image capturing apparatus 1 can detect an object, for example, based on a characteristic shape such as a number tag of a player.

The context information acquisition unit 45 acquires positional information of a plurality of objects.

The object detection unit 44 detects an object that enters a predetermined area in a real space, based on whether the position of the object acquired by the context information acquisition unit 45 is included in the predetermined area in the real space identified based on the image capturing position and the image capturing direction when the image data was captured by the image capturing unit 16.

Therefore, since the image capturing apparatus 1 can selectively select an object even from the positional information acquired, it is possible to enhance the selectivity, and it is possible to easily grasp conditions of a predetermined object from among a plurality of objects (observed persons in the present embodiment).

The context information acquisition unit 45 selectively acquires context information corresponding to an object detected by the object detection unit 44, from among context information regarding a plurality of objects.

Therefore, the image capturing apparatus 1 can selectively acquire necessary context information.

The main control unit 41 determines conditions of an object, based on context information acquired by the context information acquisition unit 45.

The output unit 18 reports a result of determining the conditions of the object by the main control unit 41.

Therefore, the image capturing apparatus 1 can be configured such that an object that is not to be selected is actively output depending on the condition.

The main control unit 41 determines a condition of an object other than the object corresponding to the context information selected and displayed by the output control unit 47.

In a case in which the main control unit 41 determines that the condition of the object is a predetermined condition, the output unit 18 displays information regarding the condition of the object, regardless of presence or absence of selection display.

Therefore, the image capturing apparatus 1 can be configured such that, in a case in which a condition of an object that is not to be selected is determined to be a predetermined condition such as being abnormal (more specifically, a bad condition), the condition of the object is actively output.

The image capturing apparatus 1 includes the storage unit 19 and the storage control unit 48.

The storage unit 19 stores context information and image data captured by the image capturing unit 16.

The storage control unit 48 controls the storage unit 19 to store context information acquired by the context information acquisition unit 45, and image data captured by the image capturing unit 16.

Therefore, with the image capturing apparatus 1, for example, context information acquired and image data captured by the image capturing unit 16 can be stored as history.

The output control unit 47 executes control to transmit and output context information, which is acquired by the context information acquisition unit 45, to external devices via the communication unit 20, etc.

Therefore, since the image capturing apparatus 1 can transmit and output context information acquired to the external devices, the history of the context information can be stored in an external storage unit, etc.

It should be noted that the present invention is not to be limited to the aforementioned embodiment, and that modifications, improvements, etc. within a scope that can achieve the object of the present invention are also included in the present invention.

The abovementioned embodiments are configured to store context information in the image capturing apparatus 1 or the sensor devices 2, but the present invention is not limited thereto. A configuration may be employed, for example, such that context information is stored in external devices via the communication function of the image capturing apparatus 1 or the sensor devices 2.

In a case in which context information is stored in an external device that can be shared by persons other than the user (the observer such as a coach) of the image capturing apparatus 1, persons (for example, medical staff, training staff, etc.) other than the observer can also utilize the context information by storing the context information and generating history in association with an ID of an observed person or a record date, and the context information can serve for creating an instruction plan or a treatment plan, based on the history.

The abovementioned embodiments are configured such that context information is mainly displayed as character information (numeric values and/or character texts), but the present invention is not limited thereto, and a configuration may be employed such that, for example, context information is schematically displayed as a graphic chart, an icon, etc.

The abovementioned embodiments are configured such that, in a case of presenting alert information or abnormal value detection, an alert is displayed or the display manner is made different from an ordinary one (for example, by displaying an alert such as a different color or a blinking effect, or by displaying an alert icon), but the present invention is not limited thereto. Regarding the presentation of alert information or abnormal value detection, a configuration may be employed to report an alert in a way different from displaying, such as through vibration or alert sound, for example.

In the abovementioned embodiment, an object is an observed person, but the present invention is not limited thereto. An object may be any object whose conditions are to be grasped or managed, and such an object may be, for example, an artifact such as a vehicle or a building, and may be a non-human object such as an animal or a plant. In a case of a vehicle, for example, a configuration may employed such that, in addition to conditions of a car body such as a car speed, fuel efficiency, and tire wear, an image from a viewpoint of a driver such as an image from a viewpoint of an on-board camera is acquired as context information. In a case of a building, for example, a configuration may be employed such that an age and deterioration conditions of a building is acquired as context information, and a scenery image from a predetermined window is acquired as context information. In a case of a plant, a configuration can be employed such that a life time and a growing environment such as moisture in soil, nutritional conditions and surrounding temperatures are acquired as context information, and in addition, an image showing a position of the sun is acquired as context information.

The abovementioned embodiments are configured such that context information is selectively acquired by the context information acquisition unit 45, but the present invention is not limited thereto. For example, a configuration may be employed such that context information is temporarily acquired, and the output control unit 47 then selects context information to be displayed as an output.

In the aforementioned embodiments, the digital camera has been described as an example of the image capturing apparatus 1 to which the present invention is applied, but the present invention is not limited thereto in particular.

For example, the present invention can be applied to any electronic device in general having a condition presentation processing function. More specifically, for example, the present invention can be applied to a lap-top personal computer, a printer, a television, a video camera, a portable navigation device, a smart phone, a cell phone device, a portable gaming device, and the like.

The processing sequence described above can be executed by hardware, and can also be executed by software.

In other words, the hardware configuration shown in FIG. 6 is merely an illustrative example, and the present invention is not particularly limited thereto. More specifically, the types of functional blocks employed to realize the above-described functions are not particularly limited to the example shown in FIG. 6, so long as the image capturing apparatus 1 can be provided with the functions enabling the aforementioned processing sequence to be executed in its entirety. A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 shown in FIG. 5 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the device main body in advance may include, for example, the ROM 12 shown in FIG. 5, a hard disk included in the storage unit 19 shown in FIG. 1 or the like, in which the program is recorded.

It should be noted that, in the present specification, the steps describing the program recorded in the storage medium include not only the processing executed in a time series following this order, but also processing executed in parallel or individually, which is not necessarily executed in a time series.

In the present specification, terminologies describing a system refer to a whole apparatus configured with a plurality of devices, a plurality of means and the like.

Although some embodiments of the present invention have been described above, the embodiments are merely exemplification, and do not limit the technical scope of the present invention. Other various embodiments can be employed for the present invention, and various modifications such as omission and replacement are possible without departing from the spirits of the present invention. Such embodiments and modifications are included in the scope of the invention and the summary described in the present specification, and are included in the invention recited in the claims as well as the equivalent scope thereof.

What is claimed is:

1. An information processing apparatus, comprising:
a designation unit that designates an arbitrary area in a real space at arbitrary timing;
an acquisition unit that acquires information regarding an object existing in the real space;
a detection unit that detects an object existing in an area designated by the designation unit at timing designated by the designation unit, among a plurality of objects existing in the real space; and
a selection-display unit that selects and displays information corresponding to the object detected by the detection unit, from among a plurality of pieces of information that can be acquired by the acquisition unit.

2. The information processing apparatus according to claim 1,
wherein the designation unit sequentially performs designation at each timing, while changing areas in the real space,
wherein the acquisition unit can acquire information regarding a plurality of objects existing in the real space, including objects existing outside an area designated by the designation unit at the each timing, and
wherein the selection-display unit selects and displays information corresponding to the object detected by the detection unit, from among a plurality of pieces of information that can be acquired by the acquisition unit at the each timing.

3. The information processing apparatus according to claim 2,
wherein the acquisition unit can concurrently acquire information regarding a plurality of objects existing in the real space, including objects existing outside an area designated by the designation unit, from sensors attached to the plurality of objects, respectively, and
wherein the selection-display unit selects and displays information acquired from a sensor attached to an object detected by the detection unit, from among a plurality of pieces of information that can be concurrently acquired from the plurality of sensors.

4. The information processing apparatus according to claim 3,
wherein the object is a person,
wherein the acquisition unit can acquire information regarding an internal condition of each person, from the sensors worn on the plurality of persons, respectively, existing in the real space, and
wherein the detection unit detects a person existing in an area designated by the designation unit at timing designated by the designation unit, among a plurality of persons existing in the real space.

5. The information processing apparatus according to claim 2, further comprising:
an image capturing unit that captures an image of an arbitrary area in the real space at arbitrary timing,
wherein the designation unit designates an area in a real space corresponding to an image capturing direction from the image capturing unit, at timing when the image capturing unit captures an image.

6. The information processing apparatus according to claim 5, further comprising:
a display unit that displays image data captured by the image capturing unit,
wherein the selection-display unit synthesizes the information thus selected and the image data captured by the image capturing unit, and displays a result on the display unit.

7. The information processing apparatus according to claim 6,
wherein the image capturing unit sequentially captures an image capturing area corresponding to an image capturing direction, while changing the image capturing direction,
wherein the display unit sequentially displays image data that is sequentially captured by the image capturing unit,
wherein the detection unit sequentially detects an object existing in a predetermined area in a real space corresponding to the image capturing direction from the image capturing unit, and
wherein the selection-display unit synthesizes information regarding an object that is sequentially detected by the detection unit, and image data that is sequentially captured by the image capturing unit, and sequentially displays a result on the display unit.

8. The information processing apparatus according to claim 5,
wherein the detection unit detects an object existing in an image capturing angle of view of the image capturing unit, based on a characteristic in terms of an image of each object, in data of an image captured by the image capturing unit.

9. The information processing apparatus according to claim 5, further comprising:
a positional information acquisition unit that acquires positional information of each of the plurality of objects,
wherein the detection unit detects an object existing in a designated area in a real space corresponding to an image capturing direction from the image capturing apparatus, based on whether a position of each object acquired by the positional information acquisition unit is included in a predetermined area in the real space identified based on an image capturing position and an image capturing direction when the image data was captured by the image capturing unit.

10. The information processing apparatus according to claim 2,
wherein the selection-display unit selects and displays information corresponding to an object detected by the detection unit, from among a plurality of pieces of information acquired by the acquisition unit; or the selection-display unit causes the acquisition unit to selectively acquire information corresponding to an object detected by the detection unit, from among a plurality of pieces of information regarding a plurality of objects existing in the real space, and displays the information acquired by the acquisition unit on the display unit.

11. The information processing apparatus according to claim 3,
wherein the acquisition unit can acquire context information regarding a context representing an internal condition or an external condition of each object, from a sensor attached to each object.

12. The information processing apparatus according to claim 4,
wherein the acquisition unit can acquire context information regarding a context representing an internal condition including a physical condition or emotion (a feeling or a psychological condition) of each person, from a sensor worn on each person.

13. The information processing apparatus according to claim 12,
wherein the context representing the internal condition of the person includes at least one of: a pulse, a respiration rate, perspiration, pupillary opening, a degree of fatigue, and an amount of exercise, of the person.

14. The information processing apparatus according to claim 2, further comprising:
a condition determination unit that determines a condition of the object, based on information acquired by the acquisition unit; and
a notification unit that reports a result of determining a condition of the object by the condition determination unit.

15. The information processing apparatus according to claim 14,
wherein the condition determination unit determines a condition of an object other than objects detected by the detection unit, and
wherein, in a case in which the determination unit determines that the condition of the object is a predetermined condition, the notification unit displays information regarding the condition of the object regardless of presence or absence of selection display by the selection-display unit.

16. The information processing apparatus according to claim 15,
wherein, in a case in which the condition determination unit determines that the condition of the object is abnormal, the notification unit reports an alert.

17. The information processing apparatus according to claim 2, further comprising:
a first storage unit that stores a plurality of pieces of information acquired by the acquisition unit; and
a first storage control unit that controls the first storage unit to additionally store information acquired by the acquisition unit at timing instructed by a user.

18. The information processing apparatus according to claim 4, further comprising:
a second storage unit that stores image data captured by the image capturing unit; and
a second storage control unit that controls the second storage unit to store image data captured by the image capturing unit, and information acquired by the acquisition unit, by associating the image data with the information, at image capturing timing instructed by a user.

19. An information processing method, comprising:
a designation step of designating an arbitrary area in a real space at arbitrary timing;
an acquisition step of acquiring information regarding an object existing in the real space;
a detection step of detecting an object existing in an area designated in the designation step at timing designated in the designation step, among a plurality of objects existing in the real space; and
a selection-display step of selecting and displaying information corresponding to the object detected in the detection step, from among a plurality of pieces of information that can be acquired in the acquisition step.

20. A non-transitory recording medium having a program stored therein, the program causing a computer to function as:
a designation unit that designates an arbitrary area in a real space at arbitrary timing;
an acquisition unit that acquires information regarding an object existing in the real space;
a detection unit that detects an object existing in an area designated by the designation unit at timing designated by the designation unit, among a plurality of objects existing in the real space; and
a selection-display unit that selects and displays information corresponding to the object detected by the detection unit, from among a plurality of pieces of information that can be acquired by the acquisition unit.
